(19) United States
(12) Patent Application Publication
(10) Pub. No.: US 2010/0086646 A1
(43) Pub. Date: Apr. 8, 2010

(54) PROBIOTIC-CONTAINING FOOD PRODUCT AND A PROTONATED WEAK MONOACID

(76) Inventors: Alan Francois, Chevannes (FR); Rémi Portier, Epinay-Sur-Orge (FR); Pascal Crepel, Gif Sur Yvette (FR); Jean-Michel Faurie, Jouy En Josas (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/517,932

(22) PCT Filed: Dec. 7, 2007
(86) PCT No.: PCT/EP07/63555

§ 371 Date: Jul. 23, 2009

(30) Foreign Application Priority Data
Dec. 8, 2006 (FR) 06/10742

(51) Int. Cl. A23L 3/3508; A23L 2/02; A23C 9/152; A23L 1/30

(52) U.S. Cl. 426/61

(57) ABSTRACT

A fresh plant juice and/or milk-based food product, comprising a stable concentration of live probiotics producing false tastes and/or gas in the initial matrix of the food product, characterized in that it contains from 1 to 20 g/l of a dietary protonated weak monoacid with a pH between 3 and 4, and a preparation method for such a food product.

The present invention relates to a fresh food product based on vegetable juices and/or milk, comprising a stable concentration of live probiotics which produce false tastes and/or gas in the initial matrix of the food product characterized in that it contains from 1-20 g/L of a dietary protonated weak mono-acid with a pH between 3 and 4, as well as a method for preparing such a food product.

Ingestion of live microorganisms called probiotics, including certain bacterial strains, in particular those which belong to the genus Lactobacillus, are particularly beneficial for health. Indeed, they have been the subject of many studies demonstrating preventive clinical effects in various fields (for example in the field of allergic symptoms, infectious diarrheas, inflammatory diseases) and on certain physiological functions (for example digestion of lactose, intestinal transit, immunity). These probiotics are notably capable of promoting proper operation of the intestinal flora which is likely to be of interest for the general population. Indeed, these bacteria produce i.a. bacteriocins and lactic acid which indirectly increase digestibility of foods, favor intestinal peristaltism and accelerate discharge of stools. Further, the bacteria produce certain vitamins of the B complex, and generally favor absorption of vitamins and minerals, reduce blood cholesterol, reinforce the immune system and line intestinal mucosas in order to protect them against invasion and activities of harmful microorganisms.

Therefore, for several years, agrifood industries have been attempting to incorporate such bacteria in their products.

Such products added with bacteria are traditionally dairy products but other food products, notably based on vegetables and in particular fruit, are of interest for developments on the agrifood industry market.

Food products based on fruit and added with bacteria of the Lactobacillus genus, are already known in the state of the art, for example in International Patent Application WO 00/70972 and European Patent Application EP 0113055.

However, in food products based on fruit added with Lactobacilli, it was possible to observe bacterial growth and/or activity which induces during storage of the products an alteration of their properties by production of gas and false tastes which makes them unsuitable for consumption.

Indeed, many microorganisms are for example capable of decarboxylating substituted cinnamic acids such as trans-4-hydroxy-3-methoxy-cinnamic acid (ferulic acid) and trans-4-hydroxy-cinnatic acid(p-coumaric acid) which may be present in milk or vegetable juices in order to respectively form the two following volatile compounds: 3-methoxy-4-hydroxystyrene(4-vinyl guaiacol) and 4-hydroxystyrene(4-vinyl phenol). These molecules are responsible for false tastes of the “phenolic, smoked, glove, medicinal . . . ” type. In bacteria of the Lactobacillus genus, p-coumaric acid and ferulic acid decarboxylase activities were detected. In particular, Lactobacilli known for these activities are the following: L. brevis, L. crispatus, L. fermentum, L. plantarum, L. pentosus, L. paracasei (Van Beck, S and Priest F G—2000—decarboxylation of substituted cinnamic acids by lactic acid bacteria isolated during malt whisky fermentation—Applied and Environmental Microbiology, 66 (12): 5322-8). Thus, via biotransformation routes, Lactobacillus strains are capable of generating false tastes from phenolic acids.

Further, many strains of the Leuconostoc, Streptococcus and Lactobacillus genera are also capable of degrading malate, citrate, pyruvate, fumarate, tartrate, and gluconate, which may be present in milk or in vegetable juices for producing gas (Hegazi F. Z., Abo-Elnaga I. G., 1980. Degradation of organic acids by dairy lactic acid bacteria. Mikrobiologie der Landwirtschaft der Technologie and des Umweltschutzes, 135 (3), 212). Thus for example, organic acids such as malic acid or citric acid, when they are degraded, unless this assimilation is accompanied by a too large production of acetate which also itself generates false tastes, do not pose these problems of generating unpleasant tastes for the consumer. Nevertheless, the assimilation of these organic acids by bacterial strains will produce this time CO₂ which will inflate the packaging of the product. Indeed, these organic acids are naturally metabolized by certain species of Lactobacilli in order to produce pyruvate (the central compound of metabolic cycles such as the carbon metabolism) and CO₂; further pyruvate is itself subject to decarboxylations accordingly increasing the rate of produced CO₂.

A food product based on fruit of the drink or fruit puree type and comprising stable live probiotics will have the advantage of providing the consumer with the benefits of fruit and of probiotics.

The National Nutrition Health Plan recommends minimum consumption of five portions of fruits and vegetables per day. Observations conducted by many scientists show that by consuming more fruits and vegetables it is notably possible to reduce cholesterol level, lipid intakes, and to limit prevalence of obesity in children.

A food product based on milk and comprising stable live probiotics will have the advantage of providing the consumer with the benefits of a dairy product and probiotics.

Several scientific studies suggest that probiotics may also play a foremost role on health. Each probiotic strain may provide specific health benefits. It is possible to find among these health benefits: an improvement of the operation of the digestive system and a reinforcement of natural defences. Certain probiotics act by absorbing proteins and others produce vitamins. Some may also produce compounds which control propagation of pathogenic bacteria and may thereby play a role in the intestinal ecosystem.

It would be desirable that the agrifood industry were able to prepare such food products, without the problems of false tastes and gas, and this is the object of the present invention.

The inventors have discovered that by adding the initial matrix of the food product comprising probiotics which naturally produce false tastes and/gas in said matrix, with a weak mono-acid in a defined pH range, the latter prevented probiotics from producing false tastes and/or gas in the food product.

However, the inventors have also shown that only weak mono-acids in a protonated form, i.e. in a medium for which the pH is less than the pKa of the weak mono-acid used, are effective for preventing probiotics from producing false tastes and/or gas in the food product.

They were able to demonstrate that a pH comprised between 3 and 4, preferentially between 3.4 and 4, still preferably between 3.4 and 3.7, was required for having an acceptable taste for the consumer, while allowing that a maximum of added weak mono-acids is in a protonated form. With the present invention, it is notably possible to propose products having a fruit concentration above 50%, and comprising live probiotics at a stable concentration.

However, as weak mono-acids are acids, they will reduce the pH of an initial already acid matrix (such as fruit juices) to below these sought pH values (between 3 and 4). Further, as weak mono-acids tend to have bad taste, it is not acceptable to put more than 50 g/L of them in a food product. This is why the present invention also relates to a method for making a fresh food product comprising a stable concentration of live probiotics which produce false tastes and/or gas in the initial matrix of the food product, characterized in that it contains from 1-20 g/L of dietary protonated weak mono-acid and in that it has a pH between 3 and 4, which comprises i.a. the steps for adjusting the pH to a target pH comprised between 3 and 4 by adding a food acid or base.

A first object of the present invention is therefore a fresh food product comprising a stable concentration of live probiotics which produce false tastes and/or gas in the initial matrix of the food product characterized in that it contains from 1-20 g/L of dietary protonated weak mono-acid, in that it has a pH comprised between 3 and 4 and in that it is stored at a temperature comprised between 0 and 15° C., preferentially between 4 and 10° C.

A fresh food product (i.e. kept at a temperature comprised between 0 and 15° C., preferentially between 4 and 10° C.), preferred in the sense of the present invention, contains more than 2.2 g/L and up to 20 g/L of dietary protonated weak mono-acid and its pH is comprised between 3.4 and 4. Such a product therefore has a dietary protonated weak mono-acid content above 2.2 g/l, with a maximum of 20 g/L and a pH above 3.4, with a maximum value of 4.

Preferentially, this amount of dietary protonated weak mono-acid is the one present in the product upon completion of its making.

By fresh food product, the intention is to designate according to the present invention, a food product which will be kept between 0 and 15° C., preferentially 4 and 10° C.

By “fresh food product” are generally meant products kept between 4 and 8° C., but it is known to one skilled in the art that the refrigerator of the consumer more generally is at a temperature comprised between 4 and 10° C. This is why the food products are formulated so as to be able to be kept at such temperatures (comprised between 4 and 10° C.).

By probiotic, the intention is to designate live microorganisms which, if they are ingested in a sufficient amount, exert a positive effect on health beyond traditional nutritional effects.

By live probiotics, the intention is to designate according to the present invention, probiotics for which the survival rate, after 28 days, in a food product according to the present invention is above 60% and advantageously above 80%.

Viability of the probiotics is measured by numbering techniques known to one skilled in the art such as for example bulk numbering, surface numbering, Malassez cells, direct counting, cloudiness, nephelometry, electronic counting, flow cytometry, fluorescence, impedancemetry, image analysis.

By stable concentration, the intention is to designate according to the present invention a concentration of live probiotics which varies by at most 50%, preferentially 10%, over a duration of 35 days from the addition of live probiotics to the initial matrix of the food product, at a temperature of 10° C.

According to the present invention, the bacteria concentration in the food product is above 10⁵, preferentially above 10⁷ CFU/mL, even more preferentially above 0.5 10⁸ CFU/mL. Most preferably, the concentration is comprised between 0.5 10⁸ and 1.5 10⁸ CFU/mL.

Thus, for example, with an initial concentration in the food product according to the present invention of 10⁸ CFU/mL, a stable concentration would be comprised between 0.5 10⁸ CFU/mL and 1.5 10⁸ CFU/mL, preferentially 0.9 10⁸ CFU/mL, and 1.1 10⁸ CFU/mL.

In particular, these probiotics may be bacterial strains.

By bacterial strains, the intention is to preferentially designate according to the present invention, lactic bacteria of genera Lactobacillus spp, Bifidobacterium spp., Streptococcus spp., Lactococcus spp., Leuconostoc spp., and in particular Lactobacillus casei, Lactobacillus plantarum, Lactobacillus bulgaricus, Lactobacillus helveticus, Lactobacillus acidophilus, Lactobacillus fermentum, Lactobacilus rhamnosus, Lactobacillus reuteri, Bifidobacterium animalis, Bifidobacterium breve, Bifidobacterium adolescentis, Bifidobacterium infantis, Streptococcus thermophilus, Lactococcus lactis, or their mixtures.

More particularly, the preferred bacterial strains according to the present invention are of the Lactobacillus or Bifidobacterium genus, preferentially Lactobacillus plantarum and even more preferentially Lactobacillus plantarum strains deposited on 16.03.95 under the number DSM 9843 at the Deutsche Sammlung von Mikroorganismen von Zellkulturen GmbH or Lactobacillus plantarum strains deposited on 04.04.2002 under the number CNCM 1-2845 at the Collection Nationale des Cultures de Microorganismes.

The Lactobacillus plantarum strains deposited on 16.03.1995 under the number DSM 9843 at the Deutsche Sammlung von Mikroorganismen von Zellkulturen GmbH is marketed by PROBI under the name of Lactobacillus plantarum 299v®. This strain has many advantages for a use as a probiotic in a fruit-based food product:
it meets probiotic criteria set by the scientific community;
it is patented, characterized (RAPD, ribotyping) and its classification is confirmed;
it is GRAS (Generally Recognized As Safe);
it is already present at a rate of 10⁸ CFU/mL in the product ProViva® distributed by Skanemejerier and has been consumed since 1994;
it has a very good survival rate at an acid pH below 4;
it is amylase negative therefore it does not degrade the texture of the finished product.

However this strain also has several drawbacks:
it has a strong post-acidification potential,
it generates significant organoleptic defects related to the synthesis of acetic acid,
it degrades citric acid (for example lemon juice, orange juice) or malic acid (for example apple or pear juice) with production of carbon dioxide whence possible inflation problems notably if the cold chain is broken (i.e. temperature exceeding 8° C.).

This strain therefore has many positive points but its use for making food products does not allow it to obtain an acceptable (notably organoleptic) quality because of this production of false tastes and/or gas.

The same applies for the strain of Lactobacillus plantarum deposited on 04.04.2002 under the number CNCM I-2845 at the Collection Nationale des Cultures des Microorganismes.

More particularly, the probiotics according to the present invention are probiotics which produce false tastes and/or gas in the initial matrix of the food product.

By initial matrix of the food product, the intention is to designate according to the present invention, a food product, preferably milk, a vegetable juice, preferably a fruit juice or vegetable juice or vegetable or fruit juices reconstituted from a concentrate, without any probiotic, non-depleted in organic acids, but optionally comprising other substances such as for example sugar, water, flavors, coloring agents, sweeteners, anti-oxygen agents, milk, preservatives, texture agents, proteins of animal origin (milk, lactoserium proteins . . . ) or of plant origin (soya bean, rice . . . ) or plant extracts (soya bean, rice . . . ).

Thus, for example, if the food product according to the present invention is based on fruit juice, added with live probiotics and with protonated weak mono-acid, the initial matrix of the food product is a fruit juice.

Also, another example may be: if the food product according to the invention is based on milk, added with live probiotics and protonated weak mono-acid, the initial matrix of the food product is milk.

According to the present invention, the food product is based on an initial matrix of vegetable juice and/or milk. This food product may be a dairy fermented product. By “fermented dairy products”, are more particularly meant fermented dairy products ready for human consumption, i.e. fermented dairy food. In the present application, this term is more particularly aimed at fermented milks and yogurts. Said fermented dairy food may alternatively be white cheeses, or petits-suisses (creamy fresh cheeses).

To the terms of “fermented milks” and “yogurts” are given their usual meanings in the field of the dairy industry, i.e. products which are intended for human consumption and which derive from the acidifying lactic fermentation of a milk substrate. These products may contain secondary ingredients such as fruit, vegetable, sugar, etc. Reference may for example be made to the French decree No. 88-1203 as of Dec. 30, 1988 relating to fermented milks and to yogurts, published in the Journal Officiel de la République Française as of Dec. 31, 1988.

Reference may also made to the “Codex Alimentarius” (prepared by the Codex Alimentarius Commission under the aegis of the FAO and of the WHO, and published by the Information Division of the FAO, available on-line at http://www.codexalimentarius.net; cf. more particularly Volume 12 of the Codex Alimentarius “Codex standards for milk and dairy products” and the “CODEX STAN A-1 1(a)-1975” standard).

The term of “fermented milk” is thus in the present application reserved for the dairy product prepared with a dairy substrate which has undergone a treatment at least equivalent to pasteurization, sown with microorganisms belonging to the species or to the characteristic species of each product. A “fermented milk” has not undergone any treatment allowing removal of a constitutive element of the dairy substrate applied and notably has not been subject to drainage of the coagulum. Coagulation of “fermented milks” should not be obtained by means other than those which result from the activity of the microorganisms used.

The term of “yogurt” as for it, is reserved for the fermented milk obtained, according to local and constant customs, by the development of specific thermophilic lactic bacteria, so-called Lactobacillus bulgaricus and Streptococcus thermophiles, which should be found live in the finished product, in an amount of at least 10 million bacteria per gram based on the milky portion.

In certain countries, regulations allow the addition of other lactic bacteria in the production of yogurt, and notably the additional use of Bifidobacterium and/or Lactobacillus acidophilus and/a Lactobacillus casei strains.

These additional lactic strains are intended to impart to the finished product, various properties, such as the property of favoring the balance of intestinal flora, or of modulating the immune system.

In practice, the term of “fermented milk” is therefore generally used for designating fermented milks other than yogurts and may assume depending on the countries the names of “Kefir”, “Kumiss”, “Lassi”, “Dahi”, “Leben”, “Filmjôlk”, “Villi”, “Acidophilus milk”, for example.

The amount of free lactic acid obtained in the fermented dairy substrate should not be less than 0.6 g for 100 g when sold to the consumer, and the protein material content supplied to the milky portion should not be less than that of normal milk.

The designation “white cheese” or “petit-suisse” is in the present application reserved for non-refined, non-salted cheese which has undergone fermentation by lactic bacteria exclusively (no fermentation other than lactic fermentation).

The dry material content of white cheeses may be lowered to 15 g or 10 g for 100 g of white cheese, depending on the whether their fat content is 25% larger than 20 g, or at most equal to 20 g, for 100 g of white cheese after complete drying. The dry material content of a white cheese is comprised between 13 and 20%. The dry material content of a petit-suisse, as for it, is not lower than 23 g for 100 g of petit-suisse. It is generally comprised between 25 and 30%. White cheeses and “petit-suisse” are generally grouped under the designation of “fresh cheeses” conventionally used in the technical field of the present invention.

By vegetable juice, the intention is to designate according to the present invention, fruit juices or vegetable juices, or reconstituted fruit or vegetable juices based on concentrate, or juice extracted from soya bean, tonyu, rice, oats, quinoa, chestnuts, almonds or hazelnuts.

The preferred fruit according to the invention are: pears, strawberries, peaches, pineapples, grapes, apples, apricots, oranges, bananas, mangoes, morello cherries, (sweet) cherries, plums, prunes, blackberries, blueberries, raspberries, grapefruits, guavas, kiwis, passion fruit, papayas, lemons, quinces, wild rose berries, litchis, pomegranates, or melons.

Preferably, the vegetable juice is fruit juice.

By false tastes, is meant an abnormal taste for the food product. A false taste is unpleasant for the consumer and therefore it is not sought. Thus, as an example for food products according to the present invention, mention may be made of the false taste of the “earthy-hay” type, via fermentation and oxidation of the product, of the “vinegar” type or of the “phenolic, smoked, gloves, medicinal . . . ” type via the ferment from organic acids present in the product, and of the “stale” type via the presence of volatile fatty acids.

The false taste of the “earthy-hay” type is the consequence of the presence of compounds such as alpha terpineol, acetoin, inalool, 4-ethylphenol.

The false taste of the “vinegar” type is the consequence of the presence of acetic acid.

False tastes of the “phenolic, smoked, glove, medicinal . . . ” type are the consequence of the presence of compounds such as 3-methoxy-4-hydroxystyrene(4-vinyl guaiacol) and 4-hydroxystyrene(4-vinyl phenol).

The false taste of the “stale” type is the consequence of the presence of compounds such as benzoic acid, 2-nonanone, decanoic acid, octanoic acid, dodecanoic acid.

In the sense of the present invention, probiotics which produce false tastes are probiotics which because of their metabolism, will be directly or indirectly responsible for the presence of one or more of these compounds selected from alpha terpineol, acetoin, inalool, 4-ethyl phenol, acetic acid, 3-methoxy-4-hydroxystyrene(4-vinyl guaiacol) and 4-hydroxy-styrene(4-vinyl phenol), benzoic acid, 2-nonanone, decanoic acid, octanoic acid, dodecanoic acid.

So-called “positive” notes may also be detected in the product, such as for example notes of the “orange” or “fruit” type. As these tastes are not unpleasant for the consumer, they are not comprised in the “false tastes” according to the present invention.

The content of molecules responsible for “false tastes” is measured by solid phase micro-extraction (SPME) associated with a gas phase chromatograph (GPC) coupled with a mass spectrometer (MS). This method was specifically developed and has increased sensitivity while having good reproducibility and good repeatability. SPME allows a specific concentration of the target volatile molecules for better quantification and better identification. GPC allows the separation of volatile molecules depending on their polarity and their molar mass and thereby peaks corresponding to each molecule may be obtained. The content of each molecule is expressed as a peak surface area i.e. in absorbance units (AU) proportional to their concentration in the sample. Finally, the mass spectrometer allows certain identification of each molecule via their fragmentation into characteristic ions on the one hand, and a second quantification of the volatile molecules on the other hand, where the content is this time expressed in mass units.

Thus, a method for identifying a probiotic which produces false tastes in the initial matrix of the food product comprises the following steps:

a) select the initial matrix of interest for the food product (for example milk and/or vegetable juice)

b) add to this initial matrix 10⁸ CFU/mL of probiotic to be tested

c) condition the product obtained in step b) (a cardboard brick of the milk brick type, plastic bottle . . . )

d) after 35 days, measure the presence and/or the content of molecules responsible for the sought “false tastes”, for example 3-methoxy-4-hydroxystyrene(4-vinyl guaiacol) and 4-hydroxystyrene(4-vinyl phenol) (or one of the compounds cited above), by solid phase micro-extraction (SPME) associated with a gas phase chromatograph (GPC) coupled with a mass spectrometer (MS), as defined above,

e) optionally have the product tested by a panel of sensorial analysis experts which will assign a score between 0 and 3, 0 being the score for “no presence of false taste in the tested product” and 3 the score for “presence of very strong false taste”, only the products having a score comprised between 0 and 1 being organoleptically acceptable,

f) identify the probiotics which produce false tastes in the initial matrix of the food product like those added in the food products for which in step d) a presence of molecules responsible for sought “false tastes”, is measured, in particular of 3-methoxy-4-hydroxystyrene(4-vinyl guaiacol) and 4-hydroxystyrene(4-vinyl phenol) (or one of the compounds mentioned above) and/or those having an average score comprised between 1 and 3 in the test by sensorial analysis expert panel of step c).

By gas, the intention is to preferentially designate CO₂ according to the present invention.

In the same way as for identifying a probiotic which produces false tastes, for identifying a probiotic which produces gas in the initial matrix of the good product, a method is used comprising the following steps:

a) select the initial matrix of interest for the food product (for example milk and/or vegetable juice)

b) add to this initial matrix 10⁸ CFU/mL of probiotic to be tested,

c) condition the product obtained in step b) in a deformable package (cardboard brick of the milk brick type, plastic bottle, yogurt pot . . . )

d) after 35 days, measure the pressure in the package,

e) optionally have the product tested by a panel of experts knowledgeable about this type of product, which will assign a score between 0 and 5, 0 being the score for “no presence of deformation of the package” and 5 the score for “maximum deformation of the package”, only the products having a score between 0 and 1 being acceptable,

f) identify the probiotics which produce gas in the initial matrix of the food product like those added in food products for which in step d) a pressure in the packaging is measured and/or those having a score between 1 and 5 in the test of the panel of experts knowledgeable about this type of product of step c).

A pressure measurement method, such as the one used in step d) is described below:

After sowing L. plantarum at a high concentration of 10⁸ CFU/mL in a fruit juice (orange juice for example), upon keeping the product in flexible containers hermetically sealed with a flexible cap (for example: a yogurt pot, a cardboard bottle, . . . ), gas evolvement may be detected. The latter may for example be characterized by rheological measurements (measurement of the resistance of the cap to crushing by a longitudinal force) or pressure measurements by directly pricking through the cap with a syringe coupled with a pressure gauge.

By aromas, the intention is to designate in the sense of the present invention, ingredients intended to impart a flavor (i.e. a taste and/or an odor) to a foodstuff.

The aromas are used with two main technological purposes:
either they reinforce the natural flavour of the foodstuff or they partially restore it if it is too low (products having lost part of their taste during the manufacturing process),
or they replace an ingredient providing an aromatic note to the finished product (for example a yogurt with a strawberry aroma).

According to the present invention, the preferred aromas are: apple, orange, red fruit, strawberry, peach, apricot, plum, raspberry, blackberry, gooseberry, lemon, citrus, grapefruit, banana, pineapple, kiwi, pear, cherry, coconut, passion fruit, mango, fig, rhubarb, melon, multifruit, exotic fruit, vanilla, chocolate, coffee, cappuccino.

By coloring agents, are meant substances capable of giving back to the food product a coloration, reinforcing or imparting the latter.

According to the present invention, the preferred coloring agents are: beta-carotene, carmine.

By sweetener, are meant substances capable of mimicking the sweetening power of sugar without however supplying the calories of the sugar.

According to the present invention, the preferred sweetening agents are: aspartame, acesulfam K, saccharine, sucralose and cyclamate.

By anti-oxygen agents, are meant substances capable of avoiding or reducing oxidation phenomena which i.a. cause rancidity of fats or browning of cut fruit and vegetables.

According to the present invention, the preferred anti-oxygen agents are: vitamin E, rosemary extract.

By milk is meant milk of animal origin (for example cow, goat, ewe) or reconstituted milks from dairy ingredients.

By preservatives, are meant substances intended to assist with preservation by preventing the presence and the development of undesirable microorganisms (for example: fungi, or bacteria responsible for food intoxications) in the final food product.

According to the present invention, the preferred preservatives are sorbic acid, ascorbic acid and sulphurous anhydride.

By texture agents, are meant substances with which the presentation or the strength of the final food product may be improved. Texture agents may be emulsifiers, stabilizers, thickeners or gelling agents. They may also be used in the food product according to the present invention alone or as a combination.

According to the present invention, the preferred texture agents are pectin, carob chip, carraghenans, alginates, guar gum, xanthan gum, starch, mono- and di-glycerides of dietary fatty acids.

By water, is optionally meant osmosed water. With osmosed water, the amount of minerals present in the final product may be limited, the minerals being also responsible for false tastes.

Potassium, chlorine, magnesium and calcium are actually rather bitter under different forms (KCl, NH₄Cl, CaCl₂, Ca acetate, LiCl, MgSO₄ . . . ) while sodium, lithium and sulphate are rather salted and/or acid depending on the form in which they are encountered (salted form: NaCl, Na₂SO₄, Na tartrate; acid form: Na₂NO₃, Li acetate; salted and acid form: Na acetate, Na ascorbate, Na citrate). In addition to these direct effects on the sensorial properties of the product, the compounds may also have a “salting out” effect on the volatile molecules responsible for false tastes of the type “smoked, phenolic . . . ” by promoting their passage into the vapour phase above the product, thereby increasing the perceived intensity of the false tastes.

Preferably according to the invention, the food product comprises between 5 and 20 g/L of dietary weak mono-acid, even more preferentially 10 to 20 g/L.

By dietary weak mono-acid, the intention is to designate according to the present invention, a weak mono-acid capable of being consumed. Preferably this is lactic acid or acetic acid, preferentially lactic acid.

By protonated weak mono-acid, the intention is to designate according to the present invention a weak mono-acid for which the acid function has not given up its H⁺ proton.

A weak acid is an acid which is not totally dissociated in water: when a weak acid AH is put into the presence of water, the following reaction occurs: AH+H₂O<=>A⁻+H₃O⁺. The reaction is not total but balanced.

A weak acid, after having given up a H⁺ proton, is transformed into a weak base.

Weak acids are classified depending on their acidity constant, i.e. depending on their capability of more or less dissociating in the presence of water. Weak acids have a pKa comprised between 3 and 11.

A mono-acid is an acid which only comprises a single acid function.

The weak mono-acid in the protonated form may naturally be present in the initial matrix of the food product, or added in the initial matrix of the food product by a method according to the present invention.

The benefit of using weak mono-acids in the protonated form is related to the antibacterial activity which depends on their capability of reducing the pH and on their capability of releasing a proton. This last capability depends on the pH of the medium as well as on the pKa value of the relevant acid. When they are in a protonated form, weak mono-acids are liposoluble and thereby have the capability of entering the microbial cells. Once they are inside the cells, these weak mono-acids are in a more alkaline medium; therefore they salt out their proton and induce a decrease in the intracellular pH. This modification influences bacterial metabolism notably by inhibiting many enzymatic activities and forcing the bacterium to use its energy by expelling the protons. This phenomenon is the first reason for the decrease in bacterial activity. Further, Russel (1992) also proposes an additional explanation based on intracellular accumulation of anions consequent to the first phenomenon (Russel, J. B., 1992. A review: another explanation for the toxicity of fermentation acids at low pH: anion accumulation versus uncoupling; J. Appl. Bacteriol. 73:363-370).

The fresh food product according to the invention preferably contains up to 7.5 g/L of dietary weak mono-acid, regardless of its form (either protonated or not).

Preferably, the pH of the food product is comprised between 3.4 and 3.7.

Preferably the pH values mentioned according to the present invention are those for a food product before conditioning or upon completion of its making. Indeed, in certain cases and for specific products such as yogurts, an acidification of the conditioned food product may be observed during its storage. This phenomenon is called post-acidification (specific acidification of the stored product).

Thus, for example a fresh food product upon completing its making and before conditioning, having a pH of 4.5, may, after conditioning, and 30 days of storage (preferentially between 4 and 10° C.), have a pH of 3.9 due to post-acidification.

According to an aspect of the invention, the fresh food product consists of 80% of water. Preferably, this food product may be a drink, preferentially based on fruit juice, on reconstituted fruit juice based on a concentrate and/or on milk.

According to the present invention, as fruit juices, mention may be made orange juices and notably

NFC (Not From Concentrate) of 10-12° Brix and as a reconstituted orange juice based on concentrate, FCOJ (Frozen Concentrate Orange Juice) at 66° Brix and other concentrated fruit juices between 10 and 70° Brix.

According to the present invention, the food product comprises between 20 and 99.99% of fruit juice, preferentially between 50 and 99.99% of fruit juice.

According to the present invention, the live probiotics comprised in the food product which produce false tastes and/or gas in the initial matrix of the food product are probiotics which degrade organic acids selected from the group comprising: malic acid, citric acid, tartaric acid, pyvuric acid, fumaric acid and gluconic acid.

More particularly, the probiotics have the capability of degrading these organic acids into CO₂ and/or into compounds generating false tastes.

Still more particularly, these organic acids are contained in the initial matrix of the food product.

By organic acids, the intention is to designate according to the present invention, notably malic acid, citric acid, tartaric acid, pyruvic acid, fumaric acid or gluconic acid.

A method for identifying the strains which degrade organic acids may be as the one shown in Example 1.

A second aspect of the present invention relates to a method for making a food product as described earlier, characterized in that it comprises the following steps:

a) adding 1 to 50 g/L of dietary weak mono-acid in the initial matrix of the food product

b) measuring the pH of the product obtained in step a)

c) adjusting the pH of the product obtained in step b) to a target pH comprised between 3 and 4, preferably comprised between 3.4 and 4 by adding a stronger dietary acid than the weak dietary mono-acid added in step a) if the pH measured in step b) is larger than the target pH or adding a dietary base if the pH measured in step b) is less than the target pH

d) adding live probiotics to the product obtained in step c).

According to the method of the present invention, in step d) are added between 5.10⁵ and 10⁹ CFU/mL of live probiotics, preferentially between 0.5.10⁸ and 1.5.10⁸ CFU/mL of live probiotics, still more preferentially 10⁸ CFU/mL.

Preferably according to the invention, in step a), between 5 and 50 g/L of dietary weak mono-acid are added.

By dietary weak mono-acid, the intention is to designate according to the present invention a weak mono-acid capable of being consumed. Preferably this is lactic acid or acetic acid, preferentially lactic acid.

The food product according to the present invention comprises a weak mono-acid in a protonated form. The percentage of protonated form in a given amount of weak mono-acid depends on the pH of the product in which it is found.

Generally, the concentration of weak mono-acid in the protonated state is correlated with the value of the pH, according to the following formula:

pH=pKa+log₁₀ [A−]/[HA], wherein

[A−] is the concentration of the base and [HA] is the concentration of the protonated form of the conjugate acid.

These concentrations are easily measurable by one skilled in the art via routine techniques (for example by HPLC).

Thus, for example, in order to obtain 1 g/L of protonated lactic acid, initially:
1.1 g/L (13 mmol/L) of lactic acid at pH 3
2.4 g/L (26 mmol/L) of lactic acid at pH 4,
   are needed.

Therefore, in the method according to the present invention, in order to obtain a food product according to the present invention, therefore comprising between 1 and 20 g/L, preferably more than 2.2 g/L and up to 20 g/L, of protonated weak mono-acid, it will be necessary to add to the initial matrix of the food product, an amount of weak mono-acid greater than or equal to the amount of desired protonated weak mono-acid in the food product, i.e. between 1 and 50 g/L of weak mono-acid.

Indeed, for example, in order to obtain 20 g/L (222 mmol/L) of protonated lactic acid, initially:
23 g/L (253 mmol/L) of lactic acid at pH 3
47 g/L (529 mmol/L) of lactic acid at pH 4,
   are needed.

By food acid, the intention is to designate according to the present invention, an acid capable of being consumed. According to the present invention and preferably, the food acid is an organic acid, preferentially an acid selected from orthophosphoric acid, citric acid, in particular citric acid monohydrate, ascorbic acid and malic acid, or their mixtures. More preferably, the selected food acid is orthophosphoric acid. Of course, these acids are all “food grade” acids.

By food base, the intention is to designate according to the present invention, a base capable of being consumed. According to the present invention, and preferably, the food base is selected from NaOH and salts more particularly selected from ammonium citrate, calcium citrate, sodium citrate, potassium salts, tricalcium dicitrate and phosphate buffer.

The invention also relates to the food fresh product capable of being obtained by the method described earlier.

According to the present invention, the target pH is preferably above 3.4 and ranges up to 4, with still preferred values comprised between 3.4 and 3.7. An error margin of the pH relatively to the target pH of 0.1 is acceptable according to the present invention.

### EXAMPLES

### Example 1

Formation of Gas by L. plantarum DSM 9843 and L. plantarum 1-2845 (deposited at the CNCM on Apr. 4, 2002) strains depending on the inoculated fruit juice.

I. Equipment and Methods:

I.1. Preparation of the Bacterial Suspensions and Inoculation of the Fruit Juices.

A first 2 ml pre-culture with DSM 9844 and 1-2845 strains is made. This pre-culture is used for 1% sowing in 100 mL of neutral MRS (i.e 10⁸-10⁹ cfu/mL).

From this second pre-culture 3×1,000 mL are sown in neutral MRS (i.e 10⁸-10⁹ cfu/mL).

For each strain, centrifugations (Beckman JA-25, rotor JA-10) are carried out with 500 mL pots in the following way:
filling of 6 pots with 330 mL of culture
centrifugation for 10 min, 12,000 G, 20° C.
removal of the supernatant and addition of 165 mL of culture
centrifugation for 10 min, 12,000 G, 20° C.
removal of the supernatant

Each obtained pellet is then taken up separately in the fruit juice to be tested and the obtained suspension is put back in the fruit juice brick which is carefully closed subsequently.

I.2. Dosages of the Organic Acids.

The retained technique consists of separating organic acids by high performance anion exchange chromatography (HPAEC). Detection of organic acids is achieved by suppressive conductimetry (SCD).

The used chromatographic system is of the DIONEX brand (type DX600) comprising a suppressive conductimetry detection system. The thermostatted conductimetry cell (type DS3) is coupled to an external auto-suppression system ASRS-ULTRA (4 mm). This electrolytic suppressor was used with a Milli-Q counter flow water recycling mode with a flow rate of 4 mL/min (a pressure of about 15 psi (103.4 kPa)).

An anion exchange column of the AS11-HC type (4 mm) is associated with a guard column of the AG11-HC type. The elution flow rate is 1.5 mL/min.

II. Results:

II.1. Bacterial Number Evaluations

Bacterial number evaluations were carried out during storage of the products in order to evaluate the survival of L. plantarum in the fruit juice matrices.

TABLE 1
Bacterial numbers of L. plantarum during
storage at 10° C. of the fruit juice matrices.

| | Time | | | |
|---|---|---|---|---|
| Strain | (d) | Orange | Apple | Grape |
| DSM | D0 | 1.8 · 10⁹ cfu/mL | 1.7 · 10⁹ cfu/mL | 9.5 · 10⁸ cfu/mL |
| 9843 | D5 | 5.0 · 10⁹ cfu/mL | 5.8 · 10⁸ cfu/mL | 4.1 · 10⁹ cfu/mL |
| I-2845 | D0 | 1.1 · 10⁹ cfu/mL | 9.8 · 10⁸ cfu/mL | 6.0 · 10⁸ cfu/mL |
| | D5 | 4.5 · 10⁹ cfu/mL | 1.6 · 10⁹ cfu/mL | 3.9 · 10⁹ cfu/mL |

II.2. Detecting the Consumption of Organic Acids During the Storage.

The dosages of organic acids were evaluated at 0 and 5 days at the same time as the number evaluations and the results are summarized in Table 1.

TABLE 2
Produced metabolites and organic acids
consumed during storage at 10° C. of fruit juice
containing L. plantarum.

| | | | Inflation | | Produced | Produced | Consumed | Consumed |
|---|---|---|---|---|---|---|---|---|
| | | | of the | | lactate | acetate | malate | citrate |
| | | Batches | bottle | pH | mmol | mmol | mmol | mmol |
| Apple | Control | D0 | − | 3.43 | 0.00 | 0.00 | 0.00 | 0.00 |
| juice | +DSM | D5 | ++ | 3.38 | 27.93 | 4.44 | 6.72 | 0.21 |
| | 9843 | | | | | | | |
| | +I-2845 | D5 | ++ | 3.39 | 40.86 | 4.38 | 21.20 | 0.19 |
| Orange | Control | D0 | − | 3.34 | 0.00 | 0.00 | 0.00 | 0.00 |
| juice | +DSM | D5 | +++ | 3.26 | 53.79 | 25.78 | 11.99 | 4.91 |
| | 9843 | | | | | | | |
| | +I-2845 | D5 | ++ | 3.27 | 48.90 | 15.60 | 13.26 | 1.42 |
| Grape | Control | D0 | − | 3.22 | 0.00 | 0.00 | 0.00 | 0.00 |
| juice | +DSM | D5 | ++ | 3.23 | 40.79 | 10.38 | 23.50 | 2.09 |
| | 9843 | | | | | | | |
| | +I-2845 | D5 | +++ | 3.24 | 44.59 | 8.16 | 33.87 | 1.43 |

From the results shown in Table 2, it is clearly apparent that malic acid is the most consumed subtrate by L. plantarum regardless of the relevant strain. This consumption is accompanied not only by productions of lactate and acetate and therefore by a substantial drop of the pH (notably in orange and apple juices), but also by gas production having a macroscopic effect on the package.

Depending on the metabolic routes presented in FIG. 1, on the absence of detection of produced formate (no action of pyruvate formate lyase), on the very low pentose content of treated fruit juices, the following CO₂ production result (expressed in moles) may be proposed:

Total CO₂=consumed malate+consumed citrate+(total produced acetate−acetate from citrate)

Thus, by replacing the acetate produced from citrate with the amount of consumed citrate:

Total CO₂=consumed malate+total produced acetate

Conclusion:

Malic acid and to a lesser extent, citric acid therefore strongly contribute to the production of gas during storage at 10° C. of fruit juices containing a high dose (>1.10⁹ cfu/mL) of L. plantarum DSM 9843 of I-2845 bacterium.

### Example 2

Goal: show that by only impacting the pH, it is not possible to decrease the activity of the applied L. plantarum in a fruit juice.

A 20% diluted orange juice is sown in order to attain an initial population of 1.10⁸ cfu/mL. Different acids are added as well as mixtures of acids in order to be in a pH range comprised between 3.3 and 3.4.

After conditioning into yogurt pots hermetically sealed with an “aluminium” cap, the pots are stored at 10° C. and tracking of the inflation (the production of CO₂ allowing macroscopic viewing of bacterial activity) is performed.

TABLE 3

| | | | | Visible |
|---|---|---|---|---|
| | Percentage | | Protonated | inflation |
| | in the | | weak mono- | of the |
| | final | | acid | products |
| | product for | | content | stored at |
| Acid type | pH = 3.3 | pH | (g/L) | +10° C. |
| Malic acid | Qsp | 3.37 | / | D + 7 |
| Citric acid | Qsp | 3.38 | / | D + 7 |
| Lactic acid | 0.40% | 3.40 | 3.0 | D + 30* |
| Orthophosphoric | Qsp | 3.30 | / | D + 7 |
| acid | | | | |
| Lactic | 0.30%/0.15% | 3.40 | 2.2 | D + 8 |
| acid/citric | | | | |
| acid | | | | |
| Lactic | 0.40%/0.15% | 3.30 | 3.1 | D + 15* |
| acid/citric | | | | |
| acid | | | | |
| Lactic | 0.40%/0.06% | 3.30 | 3.1 | Not at |
| acid/sodium | | | | D + 7* |
| citrate | | | | |
| Lactic acid | 0.50% | 3.30 | 3.9 | Not at |
| | | | | D + 7* |

*organoleptic perception not acceptable for consumers.

During storage at 10° C. for a same pH (3.37-3.40), inflation kinetics are faster if the pH is reached by adding malic and citric acids. On the contrary, the presence of lactic acid allows this inflation to be prevented. However, lowering of the pH of the product to values close to 3.3 with lactic acid (i.e. 0.4-0.5%), either associated or not with citric acid or sodium citrate, is not acceptable by the consumer because the negative organoleptic impact of lactic acid is very significant (very acid, pungent perception, . . . ).

The pH is not the lever factor for reducing metabolic activity of L. plantarum but lactic acid has a certain effect, the impact of pH/acidity dissociation was tested in Example 3.

### Example 3

Goal: define the lactic acid content/pH pair with which metabolic activity may be reduced while retaining a significant bacterial population (>10⁸ cfu/mL).

Matrix: orange juice, 100% pure juice (original pH=3.6).

Addition of lactic acid and then if necessary, adjustment of the pH by adding soda in order to attain the target value.

Sowing: 0.015% of L. plantarum DSM 9843 strain at 1.4.10¹¹ cfu/mL in 100 ml of orange juice.

TABLE 4

| | Test No. | | | | | | | | | |
|---|---|---|---|---|---|---|---|---|---|---|
| | 1 | 2 | 3 | 4* | 5* | 6 | 7 | 8 | 9 | 10 |
| pH | 3.5 | 4.5 | 4 | 4 | 4 | 3.6 | 4.5 | 4 | 4.5 | 3.5 |
| [lactic | 10 | 0 | 0 | 5 | 5 | 0 | 5 | 10 | 10 | 5 |
| acid] (g/L) | | | | | | | | | | |
| Protonated | 7 | 0 | 0 | 2.1 | 2.1 | 0 | 0.9 | 4.2 | 1.8 | 3.5 |
| weak mono- | | | | | | | | | | |
| acid | | | | | | | | | | |
| content | | | | | | | | | | |

*repeating the same conditions.

Initial bacterial populations: 2.5.10⁸ cfu/mL

Bacterial populations at D+21:
Test No. 1: 2.10⁶ cfu/mL
Test No. 6: 6.10⁷ cfu/mL→very poor organoleptic properties
Test No. 8: 4.10⁷ cfu/mL
Test No. 10: 4.5.10⁷ cfu/mL.

Regardless of the initial pH, the products which do not contain any lactic acid (tests Nos. 2, 3 and 6) all inflated as soon as D+7. At this same date, the test at high pH and low lactic acid content (test No. 7) slightly inflated. No other test inflated. This result once more confirms that pH alone does not have any influence on the metabolic activity of L. plantarum.

At D+21, the tests 1, 4, 5, 8, 9 and 10 did not inflate. For test No. 1, this lack of inflation is related to the low bacterial survival (reduction of the bacterial population by a factor 100). On the other hand, in the case of the other tests, the lack of inflation is concomitant with good survival of the bacteria (a population still above 4.10⁷ cfu/mL). With this it is possible to show the importance of the selection of the “pH/lactic acid concentration” pair.

From the whole of these tests, a target pH/lactic acid content pair was able to be defined in order to reduce the metabolic activity of L. plantarum (cf. Example 4). The target lactic acid dose will be adjusted by adding molar lactic acid and the pH will be adjusted by molar orthophosphoric acid. Indeed, the latter, which may be used in the agrifood industry and is effective for rapidly reducing the pH, has no effect on the decrease of metabolic activity (cf. Example 2).

### Example 4

First application on a fruit-based dairy drink product.

The goal of the test is to evaluate the impact on the activity of L. plantarum (population and taste in the product) of the following conditions:
rated pH of the finished product or lowered to 3.9 and 3.7 by adding orthophosphoric acid,
rated lactic acidity of the finished product or increase to 5.0 g/L by adding lactic acid.

1. Formula of the Product:

TABLE 5

| Constituents | Mass percentage (%) |
|---|---|
| Skimmed milk | 56.91 |
| 40% fat cream | 2.50 |
| Skimmed milk powder | 0.38 |
| Crystallized sugar | 5.20 |
| Lactic ferments of yogurt | 0.01 |
| Fruit preparation | 15.00 |
| Sterile water + sterilized | 20.00 |
| acid solutions | |
| TOTAL | 100.00 |

2. Preparation Methods:

The mixture of skimmed milk, cream, milk powder and sugar is made, pasteurized and then set to ferment at 38° C. by adding lactic ferments.

Fermentation is stopped at a pH of 4.60 by cooling to 4° C.

The obtained white mass is then added with fruit preparation, acid solution, sterile water and frozen L. plantarum according to the table shown in paragraph 3.

3. Details of the Tests:

In the following table, the characteristics of the different tested mixtures are detailed for 1 kilogram of finished product.

TABLE 6

| | Number of the mixture | | | | | |
|---|---|---|---|---|---|---|
| | M1 | M2 | M3 | M4 | M5 | M6 |
| Added amount | 0 | 0 | 0 | 4.33 | 4.33 | 4.33 |
| of molar lactic | | | | | | |
| acid solution | | | | | | |
| (mL) | | | | | | |
| Added amount | 0 | 13.8 | 24.3 | 0 | 12.1 | 21.0 |
| of molar | | | | | | |
| phosphoric | | | | | | |
| acid solution | | | | | | |
| (g) | | | | | | |
| pH of finished | 4.29 | 3.9 | 3.7 | 4.22 | 3.9 | 3.7 |
| product | | | | | | |
| Lactic acidity | 4.7 | 4.7 | 4.7 | 5.0 | 5.0 | 5.0 |
| of the finished | | | | | | |
| product (g/L) | | | | | | |
| Protonated | 1.3 | 2.2 | 2.8 | 1.6 | 2.4 | 3.0 |
| weak | | | | | | |
| mono-acid | | | | | | |
| content (g/L) | | | | | | |
| Added amount | 1 | 1 | 1 | 1 | 1 | 1 |
| of | | | | | | |
| L. plantarum | | | | | | |
| (g) | | | | | | |
| Initial | 1 · 10⁸ | 1 · 10⁸ | 1 · 10⁸ | 1 · 10⁸ | 1 · 10⁸ | 1 · 10⁸ |
| population of | | | | | | |
| L. plantarum | | | | | | |
| (cfu/g) | | | | | | |

4. Development and Evaluation of the Products During Their Life Time.

In the following table 7, the characteristics of the different mixtures tested during their aging at a storage temperature of 10° C. are detailed.

TABLE 7
Number of the mixture

| | M1 | M2 | M3 | M4 | M5 | M6 |
|---|---|---|---|---|---|---|
| pH D0 | 4.29 | 3.9 | 3.7 | 4.22 | 3.9 | 3.7 |
| pH D + 8 days | 3.53 | 3.40 | 3.33 | 3.51 | 3.45 | 3.37 |
| pH D + 28 days | 3.56 | 3.50 | 3.47 | 3.55 | 3.53 | 3.50 |
| pH D + 35 days | 3.52 | 3.46 | 3.44 | 3.54 | 3.47 | 3.46 |
| Initial | 1 · 10⁸ | 1 · 10⁸ | 1 · 10⁸ | 1 · 10⁸ | 1 · 10⁸ | 1 · 10⁸ |
| L. plantarum population | | | | | | |
| (cfu/g) | | | | | | |
| L. plantarum | 21 · 10⁸ | 15 · 10⁸ | 11 · 10⁸ | 15 · 10⁸ | 8.8 · 10⁸ | 7.8 · 10⁸ |
| population at | | | | | | |
| D + 21 days | | | | | | |
| (cfu/g) | | | | | | |
| Visual | 5 | 4 | 3 | 3 | 2 | 1 |
| evaluation of | | | | | | |
| the inflation | | | | | | |
| of the pots at | | | | | | |
| D + 21 days | | | | | | |
| Score of | | | | | | |
| 0 = absence to | | | | | | |
| 5 = maximum | | | | | | |
| Evaluation of | 3 | 2 | 1 | 2 | 1 | 0.5 |
| the | | | | | | |
| characteristic | | | | | | |
| odor of the | | | | | | |
| activity of | | | | | | |
| L. plantarum at | | | | | | |
| D + 21 | | | | | | |
| Score of | | | | | | |
| 0 = absence to | | | | | | |
| 3 = maximum | | | | | | |
| Evaluation of | 3 | 2 | 1 | 2 | 1 | 0.5 |
| the | | | | | | |
| characteristic | | | | | | |
| taste of the | | | | | | |
| activity of | | | | | | |
| L. plantarum at | | | | | | |
| D + 21 | | | | | | |
| Score of | | | | | | |
| 0 = absence to | | | | | | |
| 3 = maximum | | | | | | |

5. Conclusions:

For a same lactic acid content, bacterial growth of L. plantarum is reduced by lowering the pH.

For a same pH value, bacterial growth of L. plantarum is reduced by an increase in the lactic acid content.

At the minimum, this bacterial growth is 0.8 log.

For all the tested pH and lactic acidity conditions, the pH of the finished product at 35 days is comprised between 3.44 and 3.54. Therefore, it may be interesting to set oneself directly in this pH interval as soon as the product is made. This is what was tested in Example 5 with the comparison of the obtained results at pH 3.7 and 3.45.

### Example 5

Second application on a fruit-based dairy drink product.

Following the test described in Example 4, the test is conducted in order to evaluate the impact on the activity of L. plantarum (population and taste in the product) of the following modified conditions:
the pH of the finished product is lowered to 3.7 and 3.45 by adding orthophosphoric acid,
rated lactic acidity (5.4 g/L) of the finished product or increase to 7.5 g/L by adding lactic acid.

1.Formula of the Product

TABLE 8

| Constituents | Mass percentage (%) |
|---|---|
| Skimmed milk | 54.76 |
| 40% fat cream | 2.49 |
| Skimmed milk powder | 0.59 |
| Crystallized sugar | 7.15 |
| Lactic ferments of yogurt | 0.01 |
| Fruit preparation | 15.00 |
| Sterile water + sterilized | 20.00 |
| acid solutions | |
| TOTAL | 100.00 |

The sugar content of the finished product was increased to 1.95% in order to compensate the impact of the acidification product on organolepticity.

2. Preparation Methods:

The mixture of skimmed milk, cream, milk powder and sugar is made, pasteurized and then set to ferment at 38° C. by adding lactic ferments.

Fermentation is stopped at pH 4.50 by cooling to 4° C.

The obtained white mass is then added with fruit preparation, acid solution, sterile water and frozen L. plantarum according to the table shown in paragraph 3.

3. Details of the Tests:

In the following table, the characteristics of the different tests and mixtures are detailed for 1 kilogram of finished product.

TABLE 9

Number of the mixture

| | 1′ | 2′ | 3′ | 4′ |
|---|---|---|---|---|
| Added amount of molar | 0 | 23.85 | 0 | 23.85 |
| lactic acid solution mL) | | | | |
| Added amount of molar | 23.33 | 10.83 | 34.67 | 23.5 |
| phosphoric acid solution | | | | |
| (g) | | | | |
| pH of finished product | 3.7 | 3.7 | 3.45 | 3.45 |
| Lactic acidity of the | 5.4 | 7.5 | 5.4 | 7.5 |
| finished product (g/L) | | | | |
| Protonated weak mono-acid | 3.2 | 4.4 | 3.9 | 5.4 |
| content (g/L) | | | | |
| Added amount of | 1 | 1 | 1 | 1 |
| L. plantarum (g) | | | | |
| Initial population of | 1 · 10⁸ | 1 · 10⁸ | 1 · 10⁸ | 1 · 10⁸ |
| L. plantarum (cfu/g) | | | | |

4. Development and Evaluation of the Products During Their Life Time.

In the following table the characteristics of the different tested mixtures are detailed during their aging at a storage temperature of 10° C.

TABLE 10

| | Number of the mixture | | | |
|---|---|---|---|---|
| | 1′ | 2′ | 3′ | 4′ |
| pH D0 | 3.7 | 3.7 | 3.45 | 3.45 |
| pH D + 8 days | 3.69 | 3.68 | 3.49 | 3.46 |
| pH D + 22 days | 3.57 | 3.67 | 3.40 | 3.41 |
| pH D + 29 days | 3.40 | 3.46 | 3.25 | 3.28 |
| Initial L. plantarum | 1 · 10⁸ | 1 · 10⁸ | 1 · 10⁸ | 1 · 10⁸ |
| population (cfu/g) | | | | |
| L. plantarum population | 1.2 · 10⁸ | 1 · 10⁸ | 0.8 · 10⁸ | 0.7 · 10⁸ |
| at D + 22 days (cfu/g) | | | | |
| L. plantarum population | 1.3 · 10⁸ | 0.7 · 10⁸ | 0.5 · 10⁸ | 0.5 · 10⁸ |
| at D + 43 days (cfu/g) | | | | |
| Visual evaluation of the | 0 | 0 | 0 | 0 |
| inflation of the pots at | | | | |
| D + 22 days | | | | |
| Score of 0 = absence to | | | | |
| 5 = maximum | | | | |
| Evaluation of the | 1 | 0.5 | 0 | 0 |
| characteristic odor of | | | | |
| L. plantarum activity at | | | | |
| D + 22 | | | | |
| Score of 0 = absence to | | | | |
| 3 = maximum | | | | |
| Evalution of the | 1 | 1 | 3 | 0 |
| characteristic taste of | | | | |
| the L. plantarum activity | | | | |
| at D + 22 | | | | |
| Score of 0 = absence to | | | | |
| 3 = maximum | | | | |

5. Conclusions:

The L. plantarum population during aging of the product is stable (i.e. between 0.5.10⁸ and 1.5.10⁸ cfu/g) for a pH comprised between 3.45 and 3.7 and at a total lactic acidity comprised between 5.4 g/L and 7.5 g/L.

The characteristic odor of the activity of L. plantarum does not appear at pH 3.45 regardless of the lactic acidity. On the other hand, this odor is slightly present in products at pH 3.7 which remain very acceptable from the point of view of the consumer.

It is also noted that when the pH is reduced and when the lactic acidity of the product is increased, the survival of the probiotics is reduced. Therefore, reduction of the pH to below 3 and increase in the lactic acidity (i.e. more generally the weak mono-acid content regardless of its form) to above 7.5 g/L, induces bacterial mortality and thus non-stability of the probiotic.

1. A fresh food product comprising a stable concentration of live probiotics that produce false tastes and/or gas in the initial matrix of the food product, wherein the fresh food product contains from 1 to 20 g/L of dietary protonated weak mono-acid, has a pH of 3 to 4, and is stored at a temperature of 0° C. to 15° C.

2. The fresh food product according to claim 1, wherein it contains more than 2.2 g/L and up to 20 g/L of dietary protonated weak mono-acid and has a pH of 3.4 to 4.

3. The fresh food product according to claim 1, wherein it contains up to 7.5 g/L of dietary weak mono-acid.

4. The fresh food product according to claim 1, wherein the live probiotics that produce false tastes and/or gas in the initial matrix of the food product are probiotics that degrade organic acids selected from malic acid, citric acid, tartaric acid, pyruvic acid, fumaric acid, and gluconic acid.

5. The fresh food product according to claim 1, wherein it is a drink.

6. The fresh food product according to claim 5, wherein the food product is based on an initial matrix of vegetable juice and/or milk.

7. The fresh food product according to claim 6, wherein the vegetable juice is fruit juice.

8. (canceled)

9. (canceled)

10. The fresh food product according to claim 1, wherein the probiotics are bacterial strains.

11. The fresh food product according to claim 10, wherein the bacterial strains are selected from Lactobacillus strains, Bifidobacterium strains, and mixtures thereof.

12. The fresh food product according to claim 11, wherein the bacterial strains are Lactobacillus plantarum.

13. The fresh food product according to claim 12, wherein the bacterial strains are strains of Lactobacillus plantarum deposited on 16.03.1995 under the number DSM 9843 at the Deutsche Sammlung von Mikroorganismen von Zellkulturen GmbH or strains of Lactobacillus plantarum deposited on 04.04.2002 under the number CNCM I-2845 at the Collection Nationale des Cultures de Microorganismes.

14. The fresh food product according to claim 1, wherein the weak mono-acid is lactic acid or acetic acid.

15. The fresh food product according to claim 14, wherein the weak mono-acid is lactic acid.

16. The fresh food product according to claim 1, wherein the fresh food product has a pH of 3.4 to 3.7.

17. A method for making the food product according to claim 1, wherein the method comprises the following steps:
a) adding 1 to 50 g/L of dietary weak mono-acid in an initial matrix of the food product;
b) measuring the pH of the product obtained in step a);
c) adjusting the pH of the product obtained in step b) to a target pH of 3 to 4, by adding a stronger food acid than the dietary weak mono-acid added in step a) if the pH measured in step b) is larger than the target pH, or by adding a food base if the pH measured in step b) is smaller than the target pH; and
d) adding live probiotics to the product obtained in step c).

18. The method according to claim 17, wherein in step d) live probiotics are added to a concentration above 10⁵ CFU/mL.

19. The method according to claim 18, wherein in step d) live probiotics are added to a concentration of 0.5×10⁸ to 1.5×10⁸ CFU/mL.

20. The method according to claim 17, wherein the weak mono-acid is lactic acid or acetic acid.

21. The method according to claim 20, wherein the weak mono-acid is lactic acid.

22. The method according to claim 17, wherein the food acid is selected from orthophosphoric acid, citric acid, ascorbic acid, malic acid, and mixtures thereof.

23. The method according to claim 17, wherein the food base is selected from NaOH, sodium citrate, tricalcium dicitrate, phosphate buffer, and citrate buffer.

24. (canceled)

25. A fresh food product obtainable by the method according to claim 17.

26. The method according to claim 17, wherein the pH of the product obtained in step b) is adjusted to a target pH of 3.4 to 4.

27. The method according to claim 26, wherein the pH of the product obtained in step b) is adjusted to a target pH of 3.4 to 3.7.

28. The fresh food product according to claim 10, wherein the bacterial concentration is above 10⁵ CFU/mL.

29. The fresh food product according to claim 28, wherein the bacterial concentration is above 0.5×10⁸ CFU/mL.

30. The fresh food product according to claim 1, wherein the fresh food product is stored at a temperature of 4° C. to 10° C.
